(19) United States
(12) Patent Application Publication
(10) Pub. No.: US 2014/0302477 A1
(43) Pub. Date: Oct. 9, 2014

(54) INTELLIGENT INTERACTIVE REMOTE TEACHING SYSTEM

(71) Applicants: Zhuochen LIU, Shenzhen (CN); Lingying LI, Shenzhen (CN)

(72) Inventors: Zhuochen LIU, Shenzhen (CN); Lingying LI, Shenzhen (CN)

(21) Appl. No.: 14/311,439

(22) Filed: Jun. 23, 2014

Related U.S. Application Data
(63) Continuation of application No. PCT/CN2012/083092, filed on Oct. 17, 2012.

(30) Foreign Application Priority Data
Dec. 23, 2011 (CN) 201110439313.3

(51) Int. Cl. G09B 5/08

(52) U.S. Cl. CPC G09B 5/08
USPC 434/350

(57) ABSTRACT

The present invention provides an intelligent interactive remote teaching system which includes an interactive logic control unit, interactive script builder, a video player and the infrastructure. The teacher builds corresponding interactive scripts after they record the multimedia teaching video, associates the interactive scripts and the recorded multimedia teaching video, and triggers corresponding interactive content and controlling actions according to the interactive logic to realize the interaction with the learner. By using the present invention, the teacher can build the interactive script conveniently while does not know how to program. The teacher makes the repeated interactive behavior to be implemented by the intelligent interactive video, thus reduces the cost of the interactive time and space between the teacher and the learner. Further, the present invention takes the asynchronous video to integrate learning resources, that can direct the students to learn by themselves in clear targets.

### TECHNICAL FIELD

The present invention relates to an intelligent interactive remote teaching system.

### BACKGROUND

Network teaching is a teaching way by using the network as a major medium. With the development of the multimedia technology, the network interactive technology of nowadays can support that multiple types of medias, such as text, image, audio, or video, are transmitted synchronously or asynchronously. However, the advanced network interactive technology may not help to finish the network teaching successfully, the high quality interactions between teachers and students are the key point. In the remote teaching of nowadays, many factors may effect the teaching results, but one of the primary factor is the high quality interaction between teachers and students. In the long-term practice, people realized that it is necessary to practice the interactive means of modern remote teaching and take advantage of the character of the interactive function and the advancement of interactive function used in the remote teaching.

In a known technology, it is difficult to add an interactive function to a video, and a professional multimedia editing tool, such as Authorware or Flash, is required to add the interactive function to the video by the teacher, and the teacher needs know professional program knowledge to prepare the teaching courseware with interactive function. In another aspect, the interactive behaviors generated by these multimedia tools are embedded into the program file, therefore, the interactive is difficult to modify, expand, and reuse.

### SUMMARY

One of the objects of the present invention is providing an intelligent interactive remote teaching system which includes an interactive script builder. By using the interactive script builder, the teacher can generate the required interactive script while need not to program.

An intelligent interactive system is provided and includes an interactive logic control unit, an interactive script builder, and a video player. Wherein:

The interactive logic control unit is configured to trigger interactive contents and actions according to an interactive logic, and process the interactive contents and actions according to a feedback processing logic to implement control actions;

The interactive script builder is configured to set the interactive logic control unit and the interactive content, generate corresponding interactive script;

The video player is configured to get the interaction based on the video playing in response to an interactive requirement described by the interactive script which is generated by the interactive script builder.

The interactive script generated by the interactive script builder separates the interactive behaviors required by teaching and associates the interactive behaviors to the corresponding multimedia videos.

The interactive logic includes triggering the interactive behaviors according to a playing progress of the video. The interactive behaviors triggering way is not limit to the above described way, further includes triggering the interactive behaviors according to the different feedback contents from the client of the learner, or triggering the interactive behaviors randomly.

The feedback processing logic comprises a processing logic for processing the feedback information and associating a controlling action set which includes a serial of controlling actions.

The type of the controlling action includes database operations, video playing progress controls, pushing multimedia information and essay question to the learner client, directing to the other interactive content and action unit, jumping to the outside resource to learn and/or invoking the data of the client of learner to operate.

The interactive script generated by the interactive script builder and the corresponding multimedia video are uploaded to the remote teaching system in a background computer through a network.

Another object of the present invention is providing the infrastructure of the intelligent interactive remote teaching system. The interaction between the learner and the teacher are asynchrony, but the interaction between the learner and the intelligent interactive video are synchrony. The intelligent interactive video contains the interaction requirement, which is different from the common video.

The infrastructure of the intelligent interactive remote teaching system includes:

a multimedia video database being configured for storing multimedia videos associated with interactive scripts uploaded through the intelligent interactive system;

an interactive script database being configured for storing interactive scripts associated with multimedia videos uploaded through the intelligent interactive system;

an interactive resource defining database being configured for defining resources relating with interactive behaviors;

an interactive script analyzing and implementing unit being configured for loading, analyzing, and implementing the interactive scripts stored in the interactive script database, and analyzing and processing the interactive resource defining database;

an streaming media video service unit supporting interactive script control being configured to receive the multimedia video and associated interactive script sent by the multimedia video database, and providing video services with intelligent interactive function to the user of a remote client;

an interactive feedback processing unit being configured for processing feedback information of the learner of the remote client, processing interactive requiring signals, and sending the feedback information of the remote client of learner to the remote client of teacher;

The system further accepts synchronous or asynchronous interaction requirements sent by the remote client of the learner.

The present invention combines the advantages of the synchronous or asynchronous interaction. The synchronous interaction between the learner and the intelligent interactive video can distinct different levels of the learners, leaning effect, and the like. Therefore, the teacher can tailor teaching method according to individual to realize individualized teaching effect. The interactive effect may be reach or higher than the real class. Additionally, to the interactive content whose feedback content can be enumerable (namely anticipated), the teacher can associate the interactive logic and the content with the intelligent interactive video, and makes the repeated interactive behavior to be implemented by the intelligent interactive video, thus reduces the cost of the interactive time and space between the teacher and the learner. Further, the present invention takes the asynchronous video (on-demand video) as a major media to integrate different types of learning resources (such as text, image, audio, other video, network resource, and the like) to the timeline of the playing video, that can direct the students to learn by themselves in clear targets.

### BRIEF DESCRIPTION OF THE DRAWINGS

FIG. 1 is a block diagram of an intelligent interactive system for video teaching in accordance with an embodiment of the present invention.

FIG. 2 is a block diagram of an remote teaching system in accordance with an embodiment of the present invention.

### DETAILED DESCRIPTION OF THE PREFERRED EMBODIMENTS

The invention will be described combined with different embodiments below. The person skilled in the art can get the technical solution and inventive object of the present invention by means of other different replacement technical solutions without doing creative work. Therefore, the embodiments described below are aimed to describe the invention and not aimed to limit the invention.

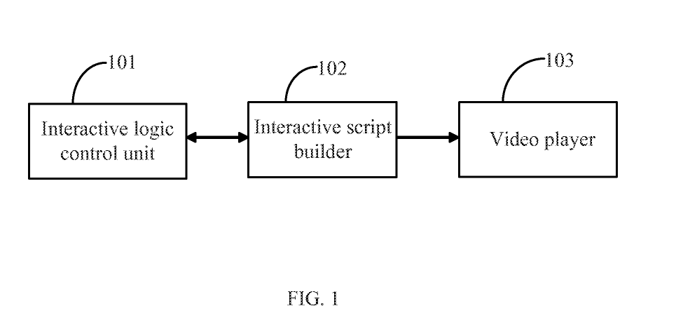

FIG. 1 is a block diagram of an intelligent interactive system for video teaching in accordance with an embodiment of the present invention. The intelligent interactive system 100 for video teaching includes an interactive logic control unit 101, an interactive script builder 102, and a video player 103. The interactive logic control unit 101 triggers interactive contents and actions according to an interactive logic, and processes the interactive contents and actions according to a feedback processing logic to implement control actions. The interactive script builder 102 is configured to set the interactive logic control unit 101 and the interactive content, generate corresponding interactive script. The video player 103 gets the interaction based on the video playing in response to an interactive requirement described by interactive script which is generated according to the interactive script builder 102.

The data entity and the interactive content transmitted between the learner and the teacher and between the learner and the teaching system are separated from the teaching video. The types of the interactive content is wide and may be a feedback form (et. form used for questionnaire, knowledge test, and leaning effect test), and also can be an explanatory note, a promotion bar, a cited network resource and so on. The interactive logic control unit 101 triggers the interactive content.

The interactive content can be divided to enumerable content (namely anticipated content) and DontEnum content (namely unanticipated content) according to the feedback result. The enumerable content refers that the learning results fed back by the leaner can be enumerable. For example, the objective choice questions or true or false questions whose answers are enumerable can be logically determined and processed respectively. In contrast, subjective essay questions, questions asked by the learner, and evaluations of learners are not easy to enumerable and not appropriate (in general) to be logically determined.

Preferably, the interactive script generated by the interactive script builder 102 separates the interactive behaviors and associates the interactive behaviors to the corresponding teaching videos.

The interactive logic includes triggering the interactive behaviors according to the playing progress of the video.

The feedback processing logic includes a processing logic for processing the feedback content and associating a controlling action set which includes a serial of controlling actions.

The type of the controlling action includes database operation video playing progress control, pushing multimedia information and essay question to the client of the learner, directing to the other interactive content and action unit, jumping to the outside resource to learn and/or invoking the data of the client of learner to operate.

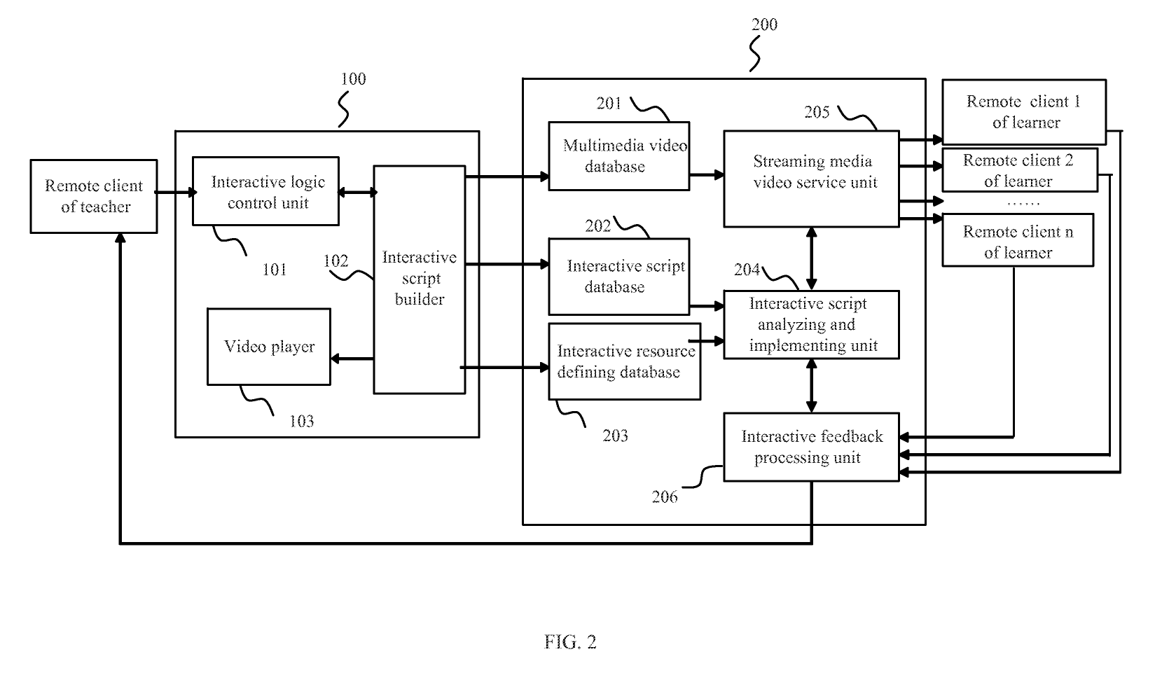

Referring to FIG. 2, the interactive script generated by the interactive script builder 102 and the corresponding multimedia video can be uploaded to the remote teaching system in the background computer through the network.

The interactive logic control unit 101 triggers corresponding interactive contents and actions according to the predefined interactive logic, further processes the interactive content and actions according to the feedback, and controls corresponding units to implement controlling actions.

Interactive script is a data entity for describing interactive behavior. The interactive script further defines an interactive logic control unit 101 and defines the interactive contents. The interactive script is stored as an editable text and separated from the multimedia teaching video. The interactive script can be generated by the interactive script builder 102 and need not to be programmed by the teacher.

The interactive behavior structured by the script which has a description feature is an important feature of the present invention. The script has the advantages of easy to be understood, high flexibility, and high extensibility.

The interactive script builder 102 enables the teacher finish a script for interacting with the learner even if the teachers do not know how to program. The interactive script builder 102 enables the teachers concentrate on how to structure the interaction process and do not concentrate on how to program the procedure when preparing the teaching video courseware with intelligent interaction function. Further, the script and the video data are stored separately, therefore, the flexibility and extensibility of the interaction are greatly improved.

FIG. 2 is a block diagram of an remote teaching system in accordance with an embodiment of the present invention. The remote teaching system 200 combined with the intelligent interactive system 100 achieves remote teaching with synchronous interaction or asynchronous interaction. The remote teaching system 200 includes a multimedia video database 201, an interactive script database 202, an interactive resource defining database 203, an interactive script analyzing and implementing unit 204, and a streaming media video service unit 205 supporting interactive script controlling, and an interactive feedback processing unit 206.

The multimedia video database 201 is configured for storing the multimedia videos associated with the interactive scripts uploaded through the intelligent interactive system 100.

The interactive script database 202 is configured for storing the interactive scripts associated with the multimedia videos uploaded through the intelligent interactive system 100.

The interactive resource defining database 203 is configured for defining the resource related to the interactive behavior.

The interactive script analyzing and implementing unit 204 is configured for loading, analyzing, and implementing the interactive script stored in the interactive script database 202, and analyzing and implementing the interactive resource defining database 203.

The streaming media video service unit 205 supporting interactive script control receives the multimedia video and associated interactive script sent by the multimedia video database 201, and provides the video service with intelligent interactive function to the user of the remote client.

The interactive feedback processing unit 206 is configured for processing the feedback information of the learner of the remote client, processing the interactive requiring signal, and sending the feedback information of the learner of the remote client of leaner to the remote client of teacher.

The remote teaching system 200 can accept the synchronous or asynchronous interaction requirements sent by the remote learner from his/her client.

The remote teaching system 200 supporting interactive script, stores and manages the teaching multimedia video database and interactive script database uploaded by the teacher, analyzes and implements interactive script, and provides streaming media video service supporting interactive script control for the network user.

The above described examples are only a few embodiments of the present invention, and the descriptions are detailed, but it should not be understood that they are not intended to limit the invention to these embodiments. It should be noted that, to the person skilled in this art, the alternatives, modifications and equivalent to the embodiments may be included within the spirit and scope of the invention. Therefore, the extent of protection of the present invention shall be determined by the attached claims.

What is claimed is:

1. An intelligent interactive remote teaching system, comprising a remote teaching system and an intelligent interactive system, wherein:
the remote teaching system comprises:
a multimedia video database being configured for storing multimedia videos associated with interactive scripts uploaded through the intelligent interactive system;
an interactive script database being configured for storing interactive scripts associated with multimedia videos uploaded through the intelligent interactive system;
an interactive resource defining database being configured for defining resources relating with interactive behaviors;
an interactive script analyzing and implementing unit being configured for loading, analyzing, and implementing the interactive script stored in the interactive script database, and analyzing and processing the interactive resource defining database;
an streaming media video service unit supporting interactive script control being configured to receive the multimedia video and associated interactive script sent by the multimedia video database, and providing video services with intelligent interactive function to the user of a remote client;
an interactive feedback processing unit being configured for processing feedback information of the learner of the remote client, processing interactive requiring signals, and sending the feedback information of the remote client of learner to the remote client of teacher;
the intelligent interactive system comprises:
an interactive logic control unit being configured to trigger interactive contents and actions according to an interactive logic, and process the interactive contents and actions according to a feedback processing logic to implement control actions;
an interactive script builder being configured to set the interactive logic control unit and the interactive content, generate corresponding interactive script;
a video player being configured to get the interaction based on the video playing in response to an interactive requirement described by the interactive script which is generated by the interactive script builder.

2. The system as claimed in claim 1, wherein the remote teaching system further accepts synchronous or asynchronous interaction requirements sent by the remote client of the learner.

3. The system as claimed in claim 1, wherein the interactive script generated by the interactive script builder separates the interactive behaviors required by teaching, and associates the interactive behaviors to the corresponding multimedia videos.

4. The system as claimed in claim 1, wherein the interactive logic comprises triggering the interactive behaviors randomly, or according to a playing progress of the video or different feedback contents from the client of the learner.

5. The system as claimed in claim 1, wherein the feedback processing logic comprises a processing logic for processing the feedback information and associating a controlling action set which includes a serial of controlling actions.

6. The system as claimed in claim 1, wherein the type of the controlling action comprises database operations, video playing progress control, pushing multimedia information and essay question to the client of the leaner, directing to the other interactive contents and action units, jumping to the outside resource to learn and/or invoking the data of the client of the learner to operate.

7. The system as claimed in claim 1, wherein the interactive script generated by the interactive script builder and the corresponding multimedia video are uploaded to the remote teaching system in a background computer through a network.
